(19) United States
(12) Patent Application Publication
(10) Pub. No.: US 2017/0345127 A1
(43) Pub. Date: Nov. 30, 2017

(54) Systems, Methods and Computer Readable Medium To Implement an Aerodrome Database

(71) Applicant: Performance Corporation, Phoenix, AZ (US)

(72) Inventors: Carlos Gameros, Peoria, AZ (US); Mike Gyde, Phoenix, AZ (US); Michael Karalewich, Glendale, AZ (US)

(73) Assignee: Performance Corporation, Phoenix, AZ (US)

(21) Appl. No.: 15/168,044

(22) Filed: May 28, 2016

(51) Int. Cl. G06T 3/00; G06F 3/0484; G06F 3/0482; G06T 3/60; G08G 5/06; G08G 5/00

(52) U.S. Cl. CPC G06T 3/0068; G08G 5/065; G08G 5/0021; G06F 3/0482; G06T 3/60; G06F 3/04845; G06T 2207/10032

(57) ABSTRACT

The invention relates to systems, methods and computer readable medium to construct map(s) of an aerodrome mapping database (AMDB). A method digitizes imagery for constructing AMDB, including entering data of the imagery into computer memory, displaying the imagery on a computer, displaying user selectable predefined target feature types that correspond to features of the imagery on the computer screen, displaying user selectable attributes of each of the predefined target feature types, automatically populating each predefined target feature type with subfeatures, associating attributes with each predefined target feature type and subfeature, snapping each predefined target feature type to coincide with the center of a pixel to provide predictability of horizontal accuracy, displaying a Bézier curve template to align a curved part of a predefined target feature type to a curved part of the imagery producing a digitized map and storing the digitized map in an AMDB.

### BACKGROUND

The invention relates to systems, methods, and computer readable medium to construct digitized airport maps for an aerodrome database.

Airport maps show pilots and ground control significant features of an airport such as runways, taxiways, aprons, de-icing areas, parking stands, construction areas, ramps, gates, terminals, control towers, and other important features. For example, after an aircraft lands on the runway it must taxi to a designated area. A pilot and the control tower require accurate up-to-date directions to maneuver the aircraft to the correct feature (e.g. runway, taxiway, and gate). The airport map significantly increases pilot awareness during taxi, for example, which can address problems that arise from the pilot's unfamiliarity with an airport or adverse weather conditions that may obscure signs and guidelines. Without the use of accurate digitized maps, pilot workload is increased which may result in pilot error and safety considerations.

An inaccurate map of an airport can also create safety issues. For example, the map could falsely indicate the aircraft's current position on the airport surface relative to active runways, taxiways, hotspots, and restricted areas. These maps can also warn that certain pavements have restricted weights allowing the pilot to navigate the safest route.

Modern geographic information system (GIS) databases contain digital data that represents the real world. In the case of airports, a database containing one digital map is referred to as an aerodrome mapping database (AMDB), and multiple maps create an aeronautical database (ADB).

Airlines, traffic controllers, and pilots have a vested interest in an accurate AMDB to query for a range of purposes. The data creating the AMDB is created through digitization (e.g., a geometric polygon) and attribution. For example, a runway at an airport may be shown in a digital image and digitized in vector form replicating the runway. In addition, the runway has attributes such as the width, visibility, and grade of pavement. Each attribute typically arises to satisfy safety standards set forth by governments and/or customer requirements. Each country may have its own standards. A user must manually add or update attributes to the airport feature within its AMDB.

A user must “build objects” that match airport features. This is labor intensive. One particular problem is how to rapidly match curvatures of specific airport features. Another problem is the inability to declare a predictable error associated with the vector data in the AMDB since it is based on a pixel based imagery.

The inventors have recognized that AMDBs have the following problems due to features being digitized via programs that are not designed specifically for airport features. Features digitized in multi-step manual processes may cause visually unacceptable looking features and accuracy limitations and non-uniform attribution. For example, when the user traces or manually draws a circular edge of an apron, it may produce an unpredictable digitization of the edge. Accuracy limitations of features occur when the points that comprise the target can only be defined to the corresponding pixel resolution. Other problems are caused when different AMDBs in an ADB are captured differently from user preferences. Finally, different units of measurements and different attribution codes may fracture the database, especially when combining data from multiple countries.

### SUMMARY OF THE INVENTION

The invention relates to implementing maps for an aerodrome database. One of the methods digitizes data from imagery for constructing map(s) for an aerodrome database, including storing data of the imagery in computer memory, displaying the imagery comprising of pixels on the computer, displaying user selectable predefined target feature types that correspond to features of the imagery on the computer, displaying user selectable attributes of each of the predefined target feature types, automatically populating each predefined target feature type with subfeatures, associating attributes with each predefined target feature type and subfeature, snapping each target feature type to coincide with the centers of pixels' to provide predictability of accuracy in producing a digitized map, and storing digitized targets and attributes in an AMDB. It also relates to a method that digitizes imagery for constructing map(s) of an aerodrome database, including entering data of the imagery into computer memory, displaying the imagery comprising pixels on the computer screen, displaying user selectable predefined target feature types that correspond to features of the imagery on the computer screen, associating attributes with each predefined target feature type and subfeature, and displaying a Bezier curve template to align a curved part of a predefined target feature of the imagery.

It also relates to a non-transitory computer-readable medium constructs map(s) for an aerodrome database, comprising instructions that perform the steps of entering data of the imagery into computer memory, displaying the imagery comprising of pixels on the computer screen, displaying user selectable predefined target feature types that correspond to features shown in the imagery on the computer screen, displaying user selectable attributes of each of the predefined target feature types, automatically populating each predefined target feature type with subfeatures, associating attributes with each predefined target feature type and subfeature, displaying a Bezier curve template to align a curved part of a predefined target feature of the imagery, and storing the digitized map in an AMDB.

### BRIEF DESCRIPTION OF THE DRAWINGS

FIG. 1 illustrates a section of runway in an airport with typical features.

FIG. 2 illustrates a computer including suitable hardware to implement an embodiment of the invention.

FIG. 3 illustrates an embodiment of aerodrome database system. It also illustrates a method that allows rapid accurate construction of aerodrome maps.

FIG. 4 illustrates menus displayed on a computer so a user can efficiently digitize the imagery. In an embodiment, the menus include predefined features, automatic subfeature population, attribution of features, and predefined attribution parameters.

FIGS. 5A-5B illustrate a method for rotating the imagery to assist the user digitizing the predefined target features.

FIGS. 6A-6B illustrate a Bézier curve template that permits a user to match a vector based curve along a target feature in the imagery by adjusting anchor points.

FIG. 7 illustrates a method of resizing and reorienting a vector object (“7”) to overlay it spatially on the imagery.

FIGS. 8A-8B illustrate image pixels representing a subfeature (e.g., solid L) which will be digitized to vector form (e.g., dotted L) and spatially snapped to the pixels' centers.

FIG. 9 illustrates methods to implement an aerodrome map for an AMDB.

FIG. 10 illustrates methods of error correction to ensure accuracy of the aerodrome map to be stored in the AMDB.

### DETAILED DESCRIPTION OF THE PREFERRED EMBODIMENTS

The following description includes the best mode of carrying out the invention. The detailed description illustrates the principles of the invention and should not be taken in a limiting sense. The scope of the invention is determined by reference to the claims. Each part (or step) is assigned its own part (or step) number throughout the specification and drawings. The method claims and drawings illustrate a specific sequence of steps, but the steps can be performed in parallel and/or in a different sequence to achieve the same result.

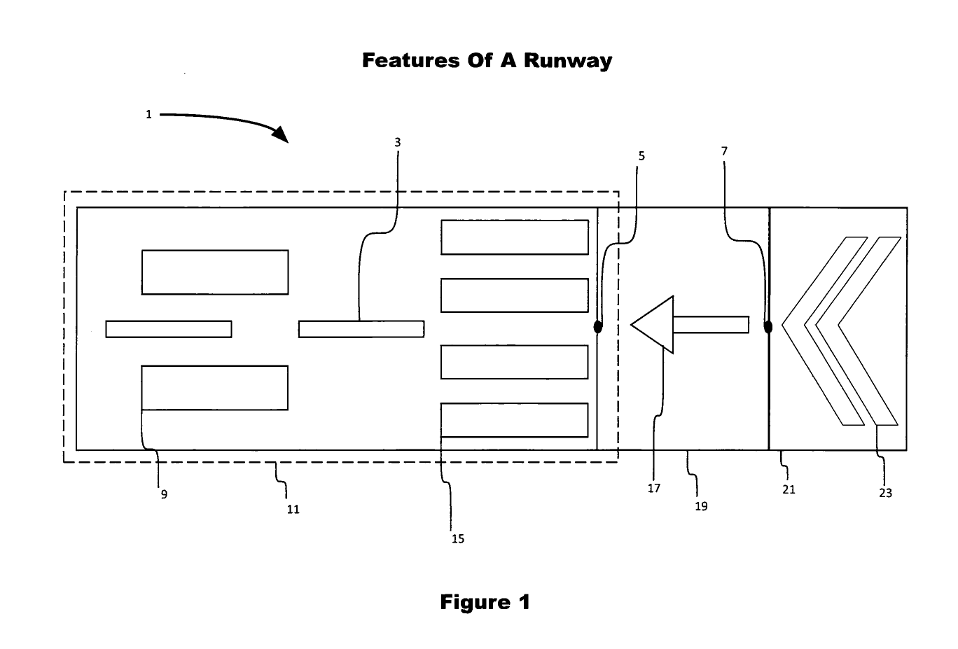

FIG. 1 illustrates a runway of an airport which is a feature with some typical attributes. The pavement of a runway 1 includes painted markings to assist the pilot in landing and taking off. As shown, the section of the runway 1 includes a centerline 3, thresholds 5 and 7, runway aiming points such as point 9, threshold marking(s) 15 in the designated landing area 11, directional arrow 17 in a takeoff region 19, stopway 21, and stopway chevrons 23. Note runways and other predefined features have various markings.

Even an airport feature such as a runway will have more than the basic outline of the runway to be digitized by the user in making the map of airport. Further, the size, colors, and locations of the markings can change over time, and depend on each country's law and regulations which can change as legislative and agencies review facts about aircraft safety.

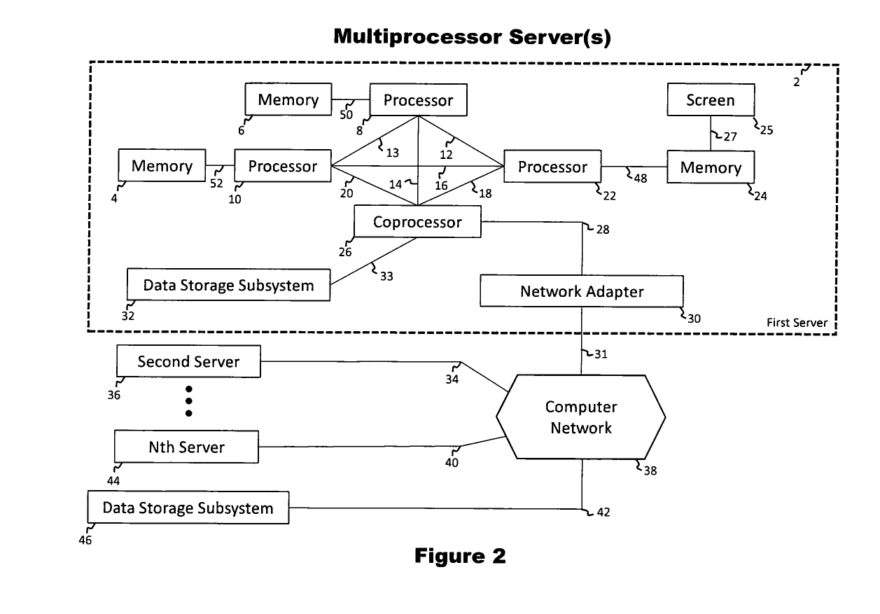

FIG. 2 illustrates a suitable hardware architecture including multiprocessors and coprocessor in server(s) that implement an embodiment of the invention.

As shown, one or more servers can execute the invention as described below. Each server is a computer that can communicate with other computers and data storage subsystems. Hennessy and Patterson, Computer Architecture: A Quantitative Approach (2012), and Patterson and Hennessy, Computer Organization and Design: The Hardware/Software Interface (2013), which are incorporated by reference herein, describe computer hardware and software, storage systems, caching, and networks.

As shown in FIG. 2, a first server 2, which is representative of the second server 36 through Nth server 46, includes a motherboard with CPU-memory buses 48, 50, and 52 that communicate between, respectively, a processor 22 and a memory 24, a processor 8 and a memory 6, and a processor 10 and a memory 4. As shown, in an embodiment, links 12, 13, 14, and 16 connect each processor (e.g., processor 10) to all of the other processors (e.g. processors 8 and 22) and a coprocessor 26. In the embodiment, the coprocessor 26 is optional not described further in connection with other drawings, and the processors used are not essential to the invention and could be any suitable general-purpose processor running software (e.g. Intel Xeon), an ASIC dedicated to perform the operations described herein or a field-programmable gate array (FPGA). Wikipedia Field-programmable gate array (2015), which is incorporated by reference herein, describes details regarding FPGAs. Each of processors 8, 10, and 22 can read and write data to their respective memory 6, 4, and 24 and/or through a link 33 to a data storage subsystem 32 (e.g., a disk, disk array, and/or solid state disk) and/or through a link 27 to a computer screen 25.

Also one could implement the invention using a single processor in each server or more than two processors to meet various performance requirements. The arrangement of the processors is not essential to the invention. Data is defined as including user data, instructions, and metadata.

A non-transitory computer-readable medium (e.g., a suitable storage device, such as a hard disk drive, solid state disk (SSD), CD, DVD, USB storage device, secure digital card (SD) card,) can be used to encode the software program instructions described in the methods below.

Each server runs an operating system such as Apple's OS X, Linux, UNIX, a Windows OS, or another suitable operating system. Anderson, et al., Operating Systems—Principles and Practice (2014), and Bovet and Cesati, Understanding the Linux Kernel (2005), which are incorporated by reference herein, describe operating systems in detail.

The coprocessor 26 of the first server 2 communicates through a link 28 with a network adapter 30 which in turn communicates over a link 31 with a computer network 38 with other servers. Similarly, the second server 36 communicates over a link 34 with the computer network 38, and the Nth server 44 communicates over link 40 with the computer network 38. In sum, the first server 2, the second server 36, and the Nth server 44 communicate with each other and with the computer network 38. A data storage subsystem 46 communicates over link 42 with computer network 38. The link 34, the link 40, the link 46, and the computer network 38 can be implemented using a bus, SAN, LAN, or WAN technology such as Fibre Channel, SCSI, InfiniBand, Ethernet, or Wi-Fi.

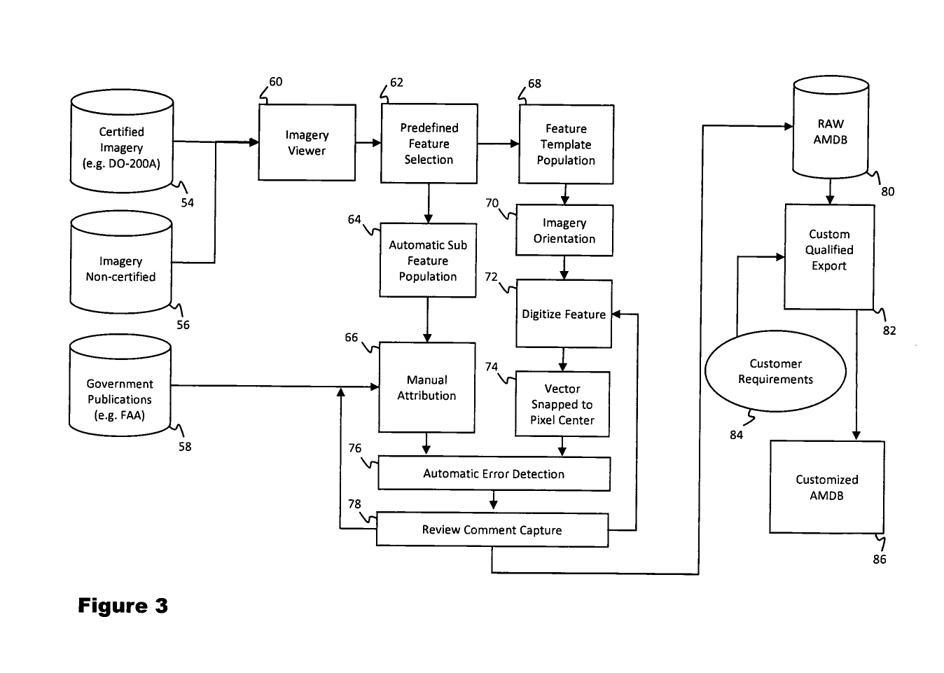

FIG. 3 illustrates a system that permits efficient and accurate construction of vector based digital maps from satellite and aerial imagery (hereinafter imagery). In an embodiment, we create maps of an airport by digitizing specific features directly from high resolution imagery.

The system can be executed on suitable hardware as shown in FIG. 2. In an embodiment, the system receives imagery into computer memory 6 such as (1) certified imagery 54 (e.g., DO-200A compliant); (2) non-certified imagery 56; and/or (3) government published data 58 (e.g., FAA).

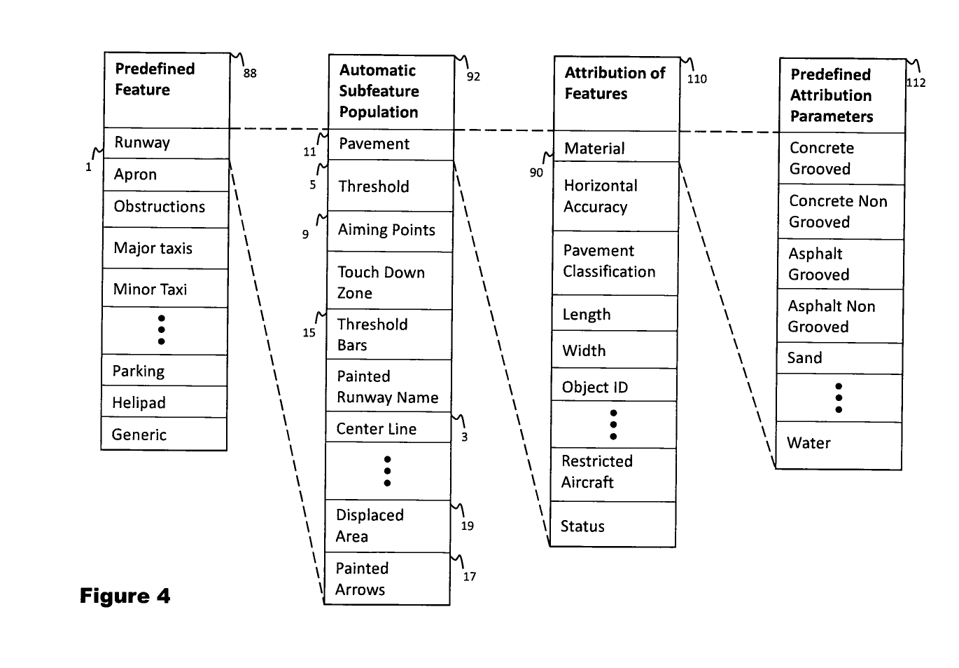

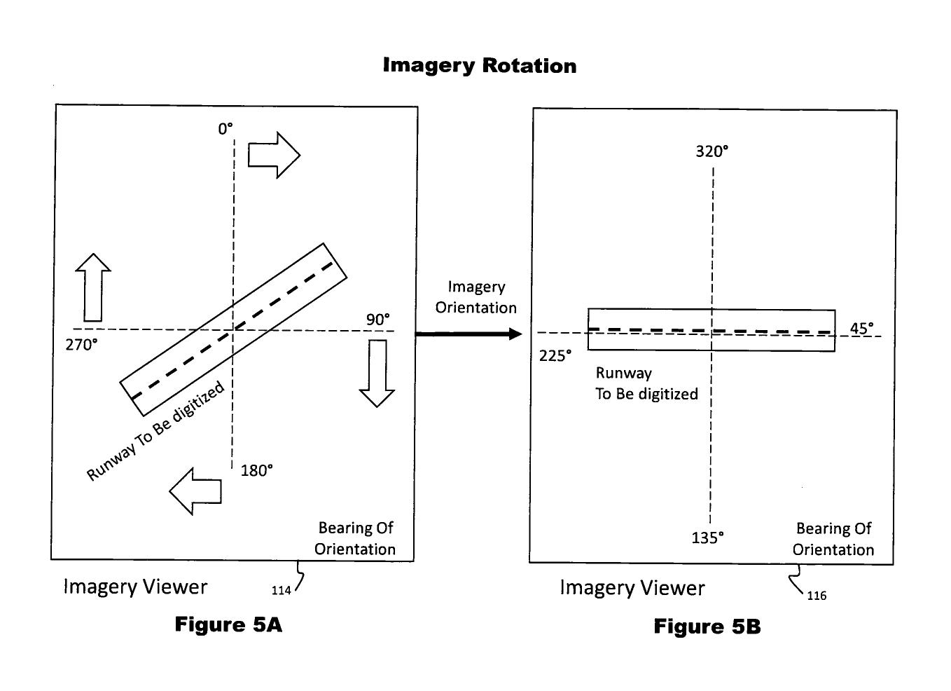

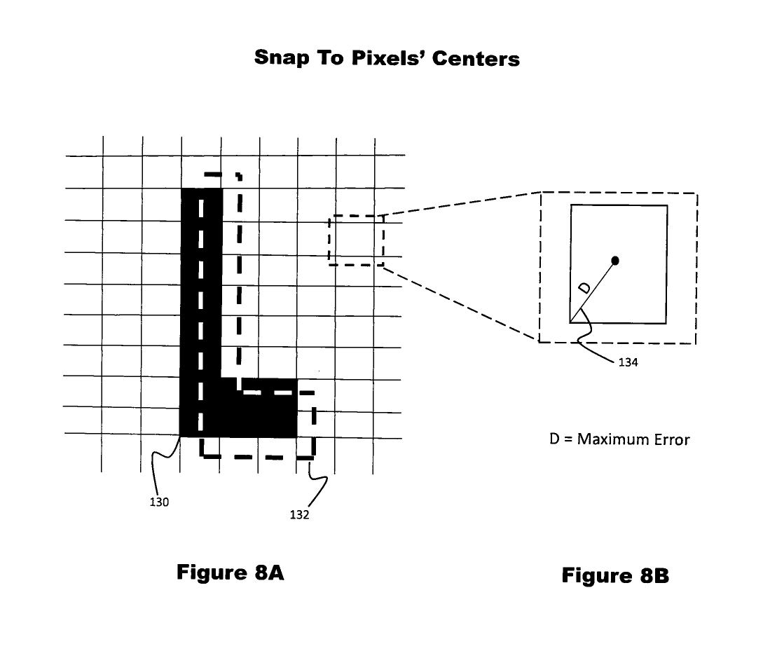

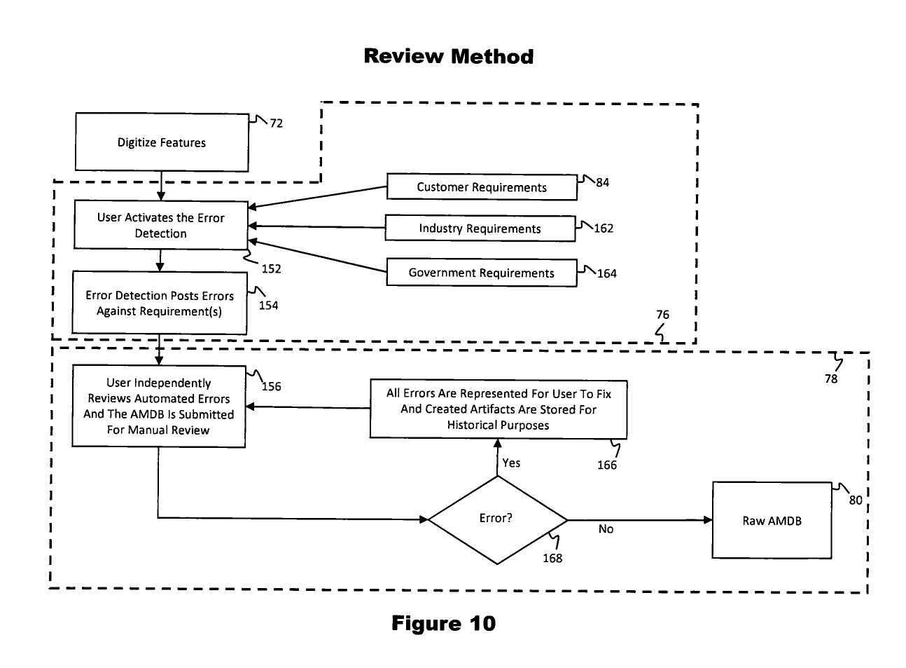

In an embodiment of the system, a imagery viewer 60 displays satellite or aerial imagery of the airport on a computer. Predefined feature selection 62 displays a list of airport features such as a runway, apron, and taxiway that the user can select using a standard I/O device (hereinafter mouse). In an embodiment, automatic subfeature population 64 adds the subfeatures (e.g., pavement) that should be associated with the selected predefined feature (e.g., runway). Manual attribution 66 displays additional attributes (e.g., runway width) to a predefined feature (e.g., runway) so the user can manually add any necessary attributes that are not added automatically. Feature template population 68 adds feature templates to save time drawing features. Imagery orientation 70 permits the user to rotate imagery in the best orientation to add a predefined feature onto the imagery. This will be discussed in more detail in FIGS. 5A-5B. Digitize feature 72 is the action that the user takes to then build the AMDB with the vector data representing the features. This will be discussed in more detail in FIG. 4. Vector snapped to pixel center 74 will center the vector data of the pixels' centers of the pixel array. This will be discussed in more detail in FIG. 8. The data output from manual attribution 66 and vector snapped to pixel center 74 may contain errors so it is reviewed in automatic error detection 76. Next, in review comment capture 78, a user independently reviews the output of automatic error detection 76 and transmits the review comments to digitize feature 72 and/or manual attribution 66, and along with the map stored in raw AMDB 80. The review is described in detail in FIG. 10. The system includes a custom qualified export 82 that receives input from customer requirements 84 and outputs a customized map satisfying unique customer requirements that is in turn stored in a customized AMDB.

FIG. 4 illustrates a computer implemented method of menus that permit efficient digitizing of the airport imagery. In an embodiment, the menus include predefined features, automatic subfeature population, attribution of features, and predefined attribution parameters in windows tiled, overlapping each other and/or the imagery. In an embodiment, if a user decides to digitize the runway shown in the imagery, the user selects “runway” from the menu “predefined features 88.” In an embodiment, the menu “automatic subfeature population 92” is displayed in conjunction with the selection of runway 1, which then automatically populates the runway with a suitable pavement 11, thresholds 5 and 7, aiming points 9, touchdown zone, threshold bars 15, a center line 3, displaced area 19, and painted arrow 17. This automatic population of the runway saves user time and reduces user error. Selecting the predefined feature option marked runway results in the display of formatted runway vector files with associated attribution. The user manipulates the vector runway to correspond to the imagery depicted. If, for example, the user selects the pavement 94 in the menu “automatic subfeature population 92,” the menu “attribution of features 110” will display additional attributes such as material, horizontal accuracy, pavement classification, length, width, object ID, restricted aircraft, and status. Further, if, for example, the user next selects the pavement material 90 in the menu “attribution of features 110,” the menu “predefined attribution parameters 112” will display additional attributes (e.g., concrete grooved, concrete non-grooved, asphalt grooved, asphalt non grooved, sand, or water) for user to manually select as the “pavement material.”

It should be recognized menus 88, 92, 110, and 112 are illustrative menus with illustrative items. Thus, some of the menus or items may not be essential to digitize any given feature of an airport. Further, the menus may show more or less of the possible items of that category as indicated by the solid dots in each menu.

FIGS. 5A and 5B illustrate a method for rotating imagery on a computer screen to assist the user digitizing a predefined feature. As illustrated in the imagery viewer 114 in FIG. 5A, the predefined feature (runway) is not aligned with the ordinate (i.e., Y-axis) or the abscissa (i.e., X-axis) line of the polar coordinate system. The center line (dotted line) of the runway is oriented about 60 degrees clockwise of the vertical line raising difficulty in digitizing the runway, because the predefined features for a runway align on the vertical and horizontal lines. To overcome this difficulty, as illustrated in imagery viewer 114, the user can select and rotate (e.g., 30 degrees clockwise) the imagery (runway) as indicated by the four arrows surrounding the runway in FIG. 5A so that the center line of the runway coincides with the horizontal line of the polar coordinate system shown in the imagery viewer 116 of FIG. 5B. In an embodiment, imagery is set by placing a line that serves as the imagery's horizon and rotating the image and orienting the user's view.

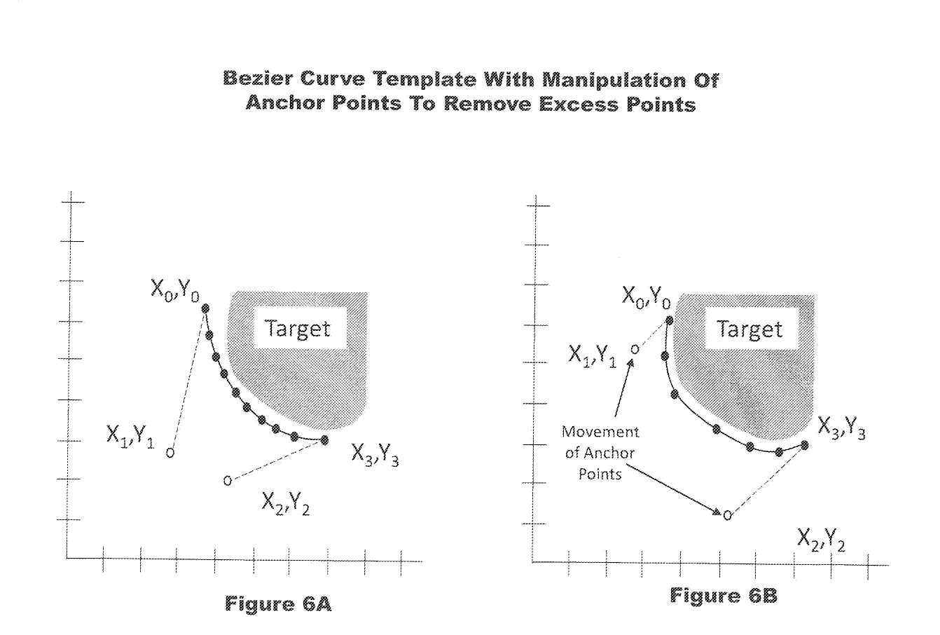

FIGS. 6A and 6B illustrate a Bézier curve template that permits a user to match a vector based curve along a target feature (e.g., an apron) in the imagery. As illustrated in FIG. 6A, the outline of the target includes curved lines that are not readily matched to any predefined features. To match the vector feature to the imagery, the user must laboriously trace along the curved edge of the imagery. The Bézier curve template provides a tool that can manipulate anchor points at X₁, Y₁, and X₂, Y₂ to manipulate a curved line between X₀, Y₀ and X₃, Y₃ as shown in FIG. 6A. As shown in FIG. 6B, as the user moves the anchor points at X₁, Y₁, and X₂, Y₂ apart from each other, the curved line between X₀, Y₀ and X₃, Y₃ will wrap around the target feature, with the minimal number of points, and remove the excess points in the curve since they are not required to accurately match the vector curve to the curved edge of the target. Using the Bezier curve allows the AMDBs in the ADB to be similarly captured, taking away differences due to different users' preferences.

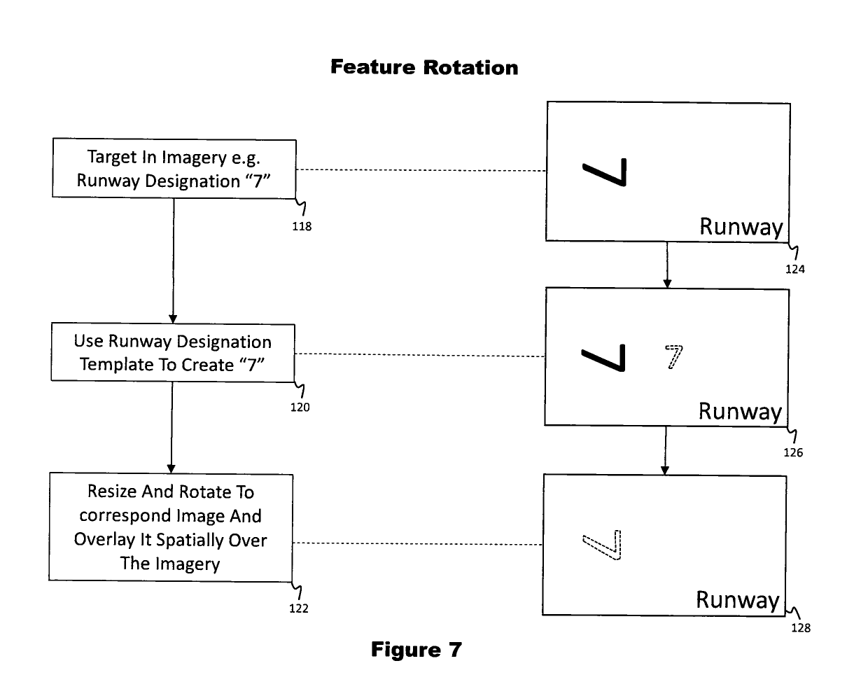

FIG. 7 illustrates methods of target feature rotation. In an embodiment, the method may include resizing and reorienting a vector object to overlay it spatially over the imagery of a target feature. At step 118, the user will be digitizing a feature. In this illustration the feature is a 7 designating a runway. The image of the runway designation “7” is shown in the imagery viewer as “solid” and rotated 90 degrees clockwise from vertical in display 124. The user can create a vector based “7” from the runway designation templates and drop it next to the imagery of “7” in the display 126. The user can then resize and rotate the vector “7” to overlay it spatially over the imagery of “7” at step 122 resulting in the display 128 in the imagery viewer.

FIGS. 8A-8B illustrate a feature (e.g., a solid L) made of image pixels that will be digitized to a vector form (e.g., a dotted L). Each of the points of the vector form is spatially snapped to the pixels' centers. Imagery accuracy is limited by its resolution which is determined by the width of pixels used. The vector corresponding to the image (e.g., the dotted L) is a polygon that encompasses lines and points. The method will automatically shift the points and the lines of the vector polygon to the pixels' centers. This allows maximum error to be less than the pixel resolution (width), because the maximum error can be no greater than “D” that is the length of hypotenuse 134 shown in FIG. 8B. This method can be used to reduce the maximum error for features or subfeature shown in the imagery determining the accuracy of the AMDB.

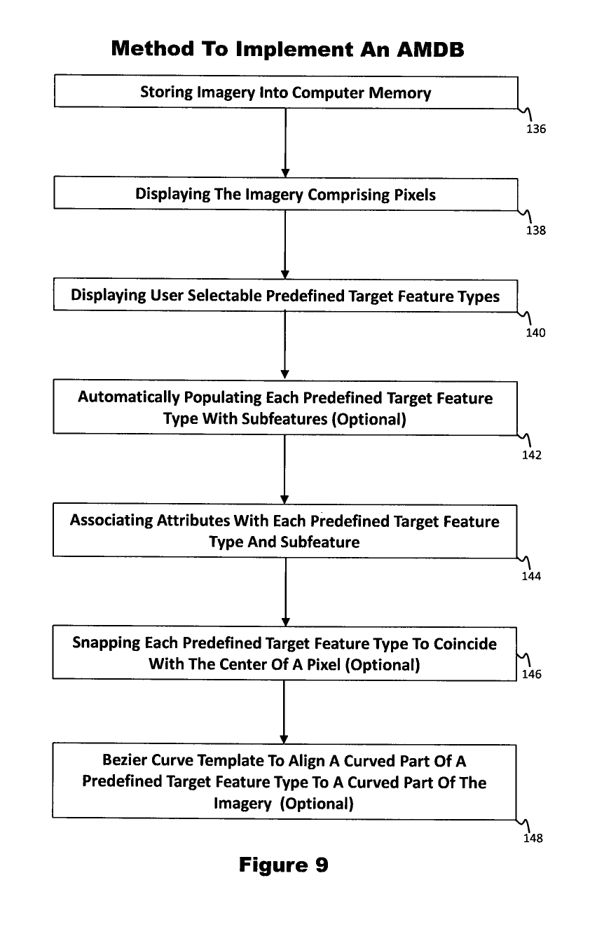

FIG. 9 illustrates computer implemented methods for constructing an aerodrome map that is stored in an AMDB. Steps 142, 146, and 148 are optional for some features, but the other steps will be typically performed to construct the aerodrome map. As shown in FIG. 9, at step 136, the method is storing imagery in raster form in computer memory. At step 138, the method is displaying the imagery comprising pixels on a computer screen. At step 140, the method is displaying user selectable predefined target feature types. At step 142, the method is automatically populating each predefined target feature type with subfeatures. At step 144, the method is associating attributes with each predefined target feature type and subfeature. At step 146, the method is snapping each predefined target feature type to coincide with the centers of the pixels. At step 148, the method is displaying a Bézier curve template to align a curved part of a predefined target feature type to a curved part of the imagery.

FIG. 10 illustrates the methods to ensure the accuracy of an AMDB. Digitizing features of an airport from the imagery may result in errors in the vector form. The methods identify these digitizing errors rapidly and reliably. Although we have automated error detection and correction, we also understand part of error detection requires human judgment, so the methods include automatic error detection 76 and manual review comment capture 78 to ensure the accuracy of the AMDB. At step 72, the method digitizes the features. The method of automatic error detection 76 begins when the user activates error detection at step 152 and reads data representing customer requirements at step 84, industry requirements 162, and/or government requirements at step 164. At step 154, the method compares the vector form to the requirement(s) to detect and posts error against the requirement(s). The output of step 154 of the automatic error detection 76 (FIG. 3) is the input into review comment capture 78 (FIG. 3). At step 156, the user reviews the automated errors and the complete AMDB is submitted for review. At step 168, a user checks if error exists. If yes, the method proceeds to step 166 where the method represents all errors for the user to fix and create artifacts and store them for historical purposes and then back to step 156. If not, the method stores the vector form in the raw AMDB 80.

What is claimed:

1. A method executed on a computer of digitizing imagery for constructing map(s) for an aerodrome database (AMDB), comprising:
storing data of the imagery in computer memory;
displaying the imagery comprising pixels on the computer screen;
displaying user selectable predefined target feature types that correspond to features of the imagery on the computer screen;
displaying user selectable attributes of each of the predefined target feature types;
automatically populating each predefined target feature type with subfeatures;
associating attributes with each predefined target feature type and subfeature;
snapping each digitized feature to coincide with the pixels' centers to provide predictability of accuracy in producing a digitized map; and
storing the digitized map in an aerodrome AMDB.

2. The method of claim 1, further comprising rotating the imagery to enable digitization of predefined target feature types.

3. The method of claim 2, wherein the imagery is set by placing a line that serves as the imagery's horizon and rotating the image and orienting the user's view.

4. The method of claim 1, further comprising displaying templates that are resizable and rotatable for the predefined target feature types and subfeatures that geographically correspond to the imagery and/or defined by government standards.

5. The method of claim 1, wherein the warnings include any attribute that does not meet the database format requirements.

6. The method of claim 1, further comprising displaying a Bézier curve template to align a curved part of a predefined target feature type to a curved part of the imagery.

7. The method of claim 1, further displaying a warning that the AMDB contains a violation of a government or customer requirement(s).

8. The method of claim 1, further comprising and storing a digitization review comment set.

9. A method executed on a computer of digitizing imagery for constructing map(s) of an aerodrome database (AMDB), comprising:
entering data of the imagery in computer memory;
displaying the imagery comprising pixels on the computer screen;
displaying user selectable predefined target feature types that correspond to features of the imagery on the computer screen;
associating attributes with each predefined target feature type and subfeature; and
digitizing a Bezier curve template to align a curved part of a predefined target feature type to a curved part of the imagery.

10. The method of claim 9, further comprising displaying user selectable attributes of each of the predefined target feature types and automatically populating each predefined target feature type with subfeatures.

11. The method of claim 9, further displaying a warning that the AMDB contains a violation of a government requirements, industry requirements, or customer requirement(s).

12. The method of claim 11, further comprising storing a predefined feature including the curved part of feature in a digitized map and
storing the digitized map in the AMDB.

13. The method of claim 9, wherein the rotating imagery is set by placing a line that serves as the imagery's horizon and rotating the image and orienting the user's view.

14. A non-transitory computer-readable medium for constructing map(s) for an aerodrome database, comprising instructions stored thereon that when executed on computer perform the steps of:
entering data of the imagery in computer memory;
displaying the imagery comprising pixels on the computer screen;
displaying user selectable predefined target feature types that correspond to features of the imagery on the computer screen;
displaying user selectable attributes of each of the predefined target feature types;
automatically populating each predefined target feature type with subfeatures;
associating attributes with each predefined target feature type and subfeature;
displaying a Bézier curve template to align a curved part of a predefined target feature type to a curved part of the imagery; and
storing the digitized map in an aerodrome AMDB.

15. The non-transitory computer-readable medium of claim 14, further comprising snapping each predefined target feature type to coincide with the center of a pixel to provide predictability of horizontal accuracy producing a digitized map.

16. The non-transitory computer-readable medium of claim 15, further comprising displaying a Bezier curve template to align a curved part of a predefined target feature type to a curved part of the imagery.

17. The non-transitory computer-readable medium of claim 16, further comprising displaying templates for the predefined target feature types and subfeatures that geographically correspond to the imagery and/or defined by government standards.
